(19) United States
(12) Patent Application Publication
(10) Pub. No.: US 2017/0290306 A1
(43) Pub. Date: Oct. 12, 2017

(54) FISH COUNTING DEVICE, FISH COUNTING METHOD, FISH COUNT PREDICTION DEVICE, FISH COUNT PREDICTION METHOD, FISH COUNTING SYSTEM, AND FISH COUNT PREDICTION SYSTEM

(71) Applicant: NEC Solution Innovators, Ltd., Tokyo (JP)

(72) Inventors: Jou AKITOMI, Tokyo (JP); Takayuki KODAIRA, Tokyo (JP); Masato TAGUCHI, Tokyo (JP); Takako NAKATANI, Tokyo (JP)

(73) Assignee: NEC SOLUTION INNOVATORS, LTD., Tokyo (JP)

(21) Appl. No.: 15/512,917

(22) PCT Filed: Aug. 12, 2015
(86) PCT No.: PCT/JP2015/072835

§ 371 Date: Mar. 21, 2017

(30) Foreign Application Priority Data
Oct. 10, 2014 (JP) 2014-208835

(51) Int. Cl. A01K 61/95; G06T 7/73; G06T 7/60

(52) U.S. Cl. CPC A01K 61/95; G06T 7/60; G06T 7/73

(57) ABSTRACT

To provide a easily fish counting device, a fish counting method, a fish count prediction device, a fish count prediction method, a fish counting system, and a fish count prediction system. The fish counting device of the present invention includes: a measurement image acquisition unit 11 configured to acquire, over time, a plurality of measurement images of a region to be measured in a passage region where a fluid containing fish passes through; a fish position acquisition unit 21 configured to acquire positions of the fish in the measurement images; a fish movement line calculation unit 22 configured to calculate movement line(s) of the fish as tracks of movements of the fish on the basis of the acquired positions; and a fish counting unit 23 configured to count the fish on the basis of the movement line(s) of the fish in the measurement images to obtain a fish count.

### TECHNICAL FIELD

The present invention relates to a fish counting device, a fish counting method, a fish count prediction device, a fish count prediction method, a fish counting system, and a fish count prediction system.

### BACKGROUND ART

For example, in aquaculture of fish, transferred fish are required to be counted. The fish are counted by visual check or manually, and the counting requires effort.

To solve this problem, the Patent Document 1 discloses a device in which a liquid containing fish is caused to flow from an upper side of an inclined channel that includes a counting portion, and fish that passed through the counting portion are counted. However, the device of the Patent Document 1 is expensive and involves costs.

### PRIOR ART DOCUMENTS

### Patent Document

Patent Document 1: WO 2013/080351

### SUMMARY OF INVENTION

### Problem to be Solved by the Invention

Hence the present invention provides an easily fish counting device, a fish counting method, a fish count prediction device, a fish count prediction method, a fish counting system, and a fish count prediction system.

### Means for Solving Problem

The present invention provides a fish counting device including:

a measurement image acquisition unit configured to acquire, over time, a plurality of measurement images of a region to be measured in a passage region where a fluid containing at least one fish passes through;

a fish position acquisition unit configured to acquire positions of the at least one fish in the plurality of measurement images;

a fish movement line calculation unit configured to calculate a movement line of the at least one fish as a track of movement of the at least one fish on the basis of the acquired positions; and

a fish counting unit configured to count the at least one fish on the basis of the movement line of the at least one fish in the plurality of measurement images, to obtain a fish count.

The present invention provides a fish counting method for counting fish, the fish counting method including:

a measurement image acquisition step of acquiring, over time, a plurality of measurement images of a region to be measured in a passage region where a fluid containing the at least one fish passes through;

a fish position acquisition step of acquiring positions of the at least one fish in the plurality of measurement images;

a fish movement line calculation step of calculating a movement line of the at least one fish as a track of movement of the at least one fish on the basis of the acquired positions; and

a fish counting step of couting the at elast one fish on the basis of the movement line of the at least one fish in the plurality of measurement images to obtain a fish count.

The present invention provides a fish count prediction device including:

the fish counting device of the present invention, the fish counting device including the measurement image acquisition unit, the fish position acquisition unit, the fish movement line calculation unit, and the fish counting unit; and

a fish count prediction unit configured to predict a fish count of the at least one fish passed through the passage region on the basis of the fish count obtained by counting, by the fish counting device, the at least one fish in the plurality of measurement images acquired within time set in advance, the time set in advance, and total time required for the fluid containing the at least one fish to pass through the passage region.

The present invention provides a fish count prediction method including:

the fish counting method of the present invention, the fish counting method including: the measurement image acquisition step, the fish position acquisition step, the fish movement line calculation step, and the fish counting step; and

a fish count prediction step of predicting a fish count of the at least one fish passed through the passage region on the basis of the fish count obtained by counting, by the fish counting method, the at least one fish in the plurality of measurement images acquired within time set in advance, the time set in advance, and total time required for the fluid containing the at least one fish to pass through the passage region.

The present invention provides a program configured to execute the fish counting method of the present invention or the fish count prediction method of the present invention on a computer.

The present invention provides a computer-readable recording medium including the program of the present invention recorded thereon.

The present invention provides a fish counting system including:

a terminal; and

a server, wherein

the terminal and the server are connectable to each other via a communication network outside the fish counting system,

the terminal includes:
a measurement image acquisition unit configured to acquire, over time, a plurality of measurement images of a region to be measured in a passage region where a fluid containing at least one fish passes through; and
an output unit configured to output a fish count obtained by counting the at least one fish,

the server includes:
a fish position acquisition unit configured to acquire positions of the at least one fish in the plurality of measurement images;
a fish movement line calculation unit configured to calculate a movement line of the at least one fish as a track of movement of the at least one fish on the basis of the acquired positions; and
a fish counting unit configured to count the at least one fish on the basis of the movement line of the at least one fish in the plurality of measurement images to obtain a fish count.

The present invention provides a fish count prediction system including:

a terminal; and

a server, wherein

the terminal and the server are connectable to each other via a communication network outside the fish count prediction system,

the terminal includes:
a measurement image acquisition unit configured to acquire, over time, a plurality of measurement images of a region to be measured in a passage region where a fluid containing at least one fish passes through within time set in advance; and

an output unit configured to output a predicted fish count,

the server includes:
a fish position acquisition unit configured to acquire positions of the at least one fish in the plurality of measurement images;
a fish movement line calculation unit configured to calculate a movement line of the at least one fish as a track of movement of the at least one fish on the basis of the acquired positions;
a fish counting unit configured to count the at least one fish on the basis of the movement line of the at least one fish in the plurality of measurement images to obtain a fish count; and
a fish count prediction unit configured to predict a fish count of the at least one fish passed through the passage region on the basis of the fish count obtained by counting, by the fish counting unit, the at least one fish in the plurality of measurement images within time set in advance, the time set in advance, and total time required for the fluid containing the at least one fish to pass through the passage region.

### Effects of the Invention

The present invention can provide an easily fish counting device, a fish counting method, a fish count prediction device, a fish count prediction method, a fish counting system, and a fish count prediction system.

### BRIEF DESCRIPTION OF DRAWINGS

FIG. 1 is a block diagram of a fish counting device according to an embodiment (the first embodiment) of the present invention.

FIG. 2 is a block diagram of another fish counting device according to the embodiment (the first embodiment) of the present invention.

FIG. 3 is a block diagram of still another fish counting device according to the embodiment (the first embodiment) of the present invention.

FIG. 4 is a flowchart of a fish counting method and a program according to the embodiment (first embodiment) of the present invention.

FIG. 5 is a flowchart of a fish counting method and a program according to a modification (first modification) of the present invention.

FIG. 6 is a block diagram of a fish counting device according to an embodiment (second embodiment) of the present invention.

FIG. 7 is a flowchart of a fish counting method and a program according to the embodiment (second embodiment) of the present invention.

FIG. 8 is a flowchart of a fish counting method and a program according to a modification (second modification) of the present invention.

FIG. 9 is a block diagram of a fish count prediction device according to an embodiment (third embodiment) of the present invention.

FIG. 10 is a block diagram of another fish count prediction device according to the embodiment (third embodiment) of the present invention.

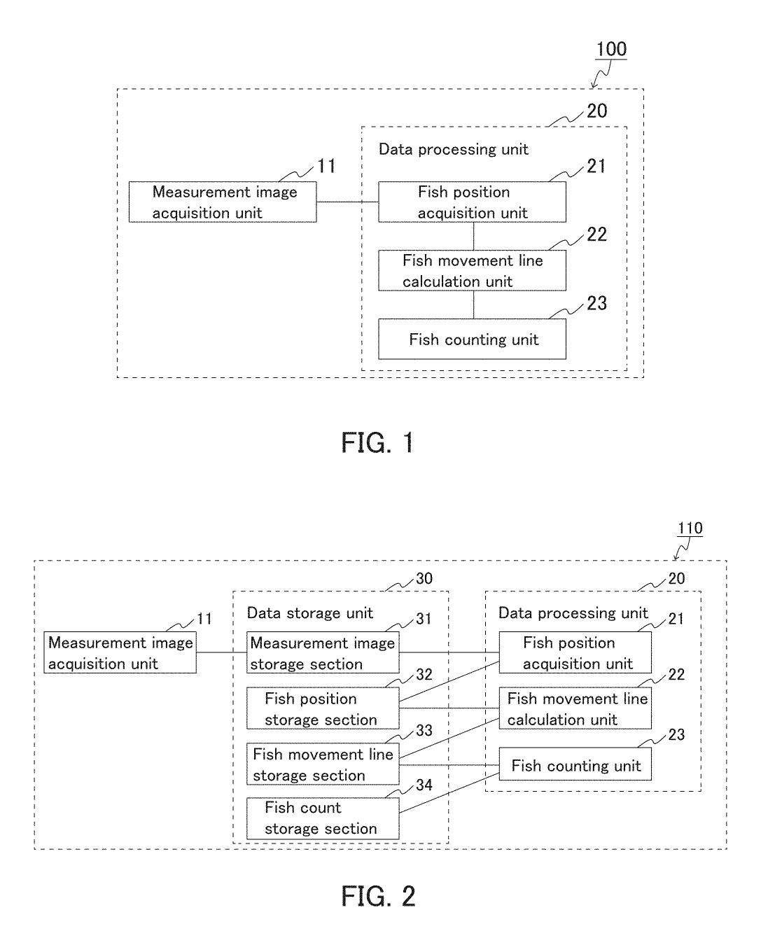

FIG. 1 is a block diagram of still another fish count prediction device according to the embodiment (third embodiment) of the present invention.

FIG. 12 is a flowchart of a fish count prediction method and a program according to the embodiment (third embodiment) of the present invention.

FIG. 13 is a schematic view of an operation screen of a fish counting device according to an embodiment (fourth embodiment) of the present invention.

FIG. 14 is a flowchart of an operation of a fish counting device according to an embodiment (fourth embodiment) of the present invention.

FIG. 15 is a block diagram of a fish counting system according to the embodiment (sixth embodiment) of the present invention.

FIG. 16 is a block diagram of a fish count prediction system according to an embodiment (seventh embodiment) of the present invention.

### DESCRIPTION OF EMBODIMENTS

In the present invention, the “fish” mean fish and shellfish. Examples of the fish and shellfish include fish and crustacea. The fish are not limited to particular fish, and examples thereof include flathead gray mullet, a sardine, an eel, a tuna, an eastern little tuna, an amberjack, a globefish, a flounder, a sea-bream, a greater amberjack, a horse-mackerel, and chub mackerel. Examples of the crustacea include shrimps. In the present invention, one or more kinds of fish may be used.

The following describes embodiments of the present invention. The present invention, however, is by no means limited thereto. In FIGS. 1 to 16, the identical parts are denoted by identical reference numerals. Each of the embodiments can be described with reference to the description of the other embodiments, unless otherwise mentioned. The configurations of the embodiments can be combined, unless otherwise mentioned.

### First Embodiment

FIG. 1 is a block diagram of a fish counting device according to the present embodiment. As shown in FIG. 1, a fish counting device 100 according to the present embodiment includes, as main components, a measurement image acquisition unit 11, a fish position acquisition unit 21, a fish movement line calculation unit 22, and a fish counting unit 23. As shown in FIG. 1, the fish position acquisition unit 21, the fish movement line calculation unit 22, and the fish counting unit 23 may be incorporated in a data processing unit 20 or may be software or hardware incorporating the software. In the fish counting device 100 according to the present embodiment, the measurement image acquisition unit 11 is electrically connected to the fish position acquisition unit 21, the fish position acquisition unit 21 to the fish movement line calculation unit 22, and the fish movement line calculation unit 22 to the fish counting unit 23. The data processing unit 20 may include, for example, a CPU.

The measurement image acquisition unit 11 acquires, over time, a plurality of measurement images of a region to be measured in a passage region where a fluid containing fish passes through. The measurement image acquisition unit 11 is not limited to particular units, and examples thereof include an imaging unit configured to take the measurement images and a data storage unit configured to store the taken measurement images. Examples of the imaging unit include: a still camera; a video camera; and camera-equipped mobile terminals such as a camera-equipped mobile phone, a camera-equipped smartphone, and a camera-equipped tablet terminal; a web camera-equipped computer; and a camera-equipped head-mounted display. Examples of the data storage unit include a random access memory (RAM), a read-only memory (ROM), a flash memory, a hard disc (HD), an optical disc, and a floppy (registered trademark) disc (FD). The data storage unit may be an internal data storage memory or an external data storage memory such as an external storage.

The region to be measured may be, for example, a part or the whole of the passage region where a fluid containing fish passes through. The measurement images of the region to be measured, calculated over time may be images of the same region (i.e., images of one place) or images of a plurality of parts in the region to be measured (images of a plurality of places). In the latter case, in a specific example, the measurement images can be images of a plurality of parts overlapping with one another in the region to be measured.

The measurement images may be images of only the region to be measured or images of a region including the region to be measured. In the latter case, the measurement images may be, for example, images of a region including the region to be measured and another region(s). Another region(s) can be, for example, a region other than the passage region where a fluid containing fish passes through. The measurement images can be acquired by taking images with the imaging unit at the time when a fluid containing fish passes through the passage region. The measurement images thus may include one or both of an image including the fish and an image including no fish. The fluid is not limited to particular fluids and can be determined, as appropriate, according to the kinds of the fish. Examples of the fluid include water, fresh water, seawater, and artificial seawater. The measurement images are preferably obtained by taking images of a region to be measured in a passage region where a fluid containing fish passes through on a monochrome background for improving the accuracy of detecting the fish in the measurement images. The monochrome background can be, for example, a white background.

The frequency of acquiring the measurement images at the time when the fish pass through the region to be measured is not limited to particular frequencies. The lower limit is, for example, 3 FPS (Flames Per Second), preferably 12 FPS, more preferably 20 FPS, and the upper limit is not limited to particular values.

The number of the measurement images is only required to be plural, and the upper limit is not limited to particular values. The number of the measurement images is two or more, preferably three or more, more preferably five or more.

The fish position acquisition unit 21 acquires the position(s) of the fish in each of the plurality of measurement images. Examples of the position of each fish include the position of one body part of each fish, an average of positions of two body parts of each fish, the position of the center of gravity of each fish, and the position (of the pixel) at the maximum of the feature quantity such as the brightness. The body part of each fish is not limited to particular parts, and examples thereof include an eye, a jaw, and a fin such as a dorsal fin, a ventral fin, a caudal fin, a pectoral fin, and an anal fin.

The fish movement line calculation unit 22 calculates the movement line(s) of the respective fish as tracks of movements of the respective fish on the basis of the positions of the fish in the plurality of the measurement images. The movement lines of the respective fish are, for example, tracks of movements of the respective fish in the region to be measured.

The fish counting unit 23 counts the fish on the basis of the movement line(s) of the respective fish in the measurement images to obtain a fish count.

For example, in the fish counting device according to the present embodiment, information on the measurement images is stored in the measurement image acquisition unit 11, information on the positions of the fish are stored in the fish position acquisition unit 21, information on the movement lines of the respective fish are stored in the fish movement line calculation unit 22, and information on the obtained fish count is stored in the fish counting unit 23. The present invention, however, is by no means limited thereto, and the information may be stored in the data storage unit, and a subsequent unit may read the information out of the data storage unit.

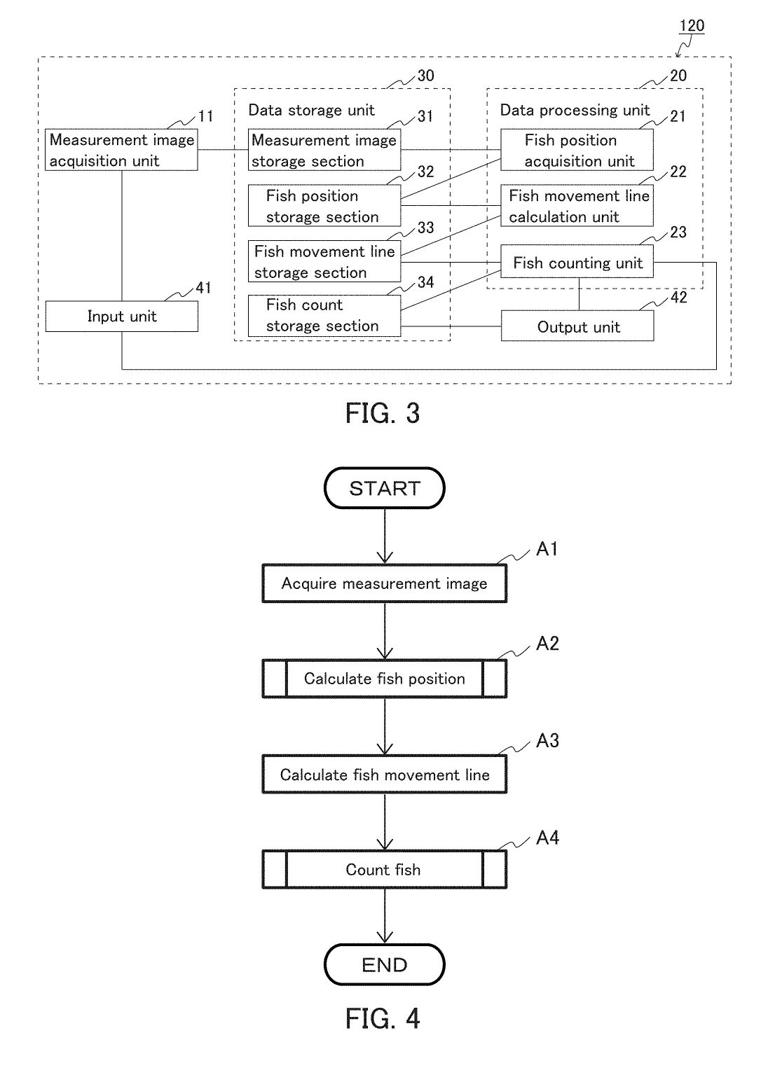

FIG. 2 is a block diagram of another fish counting device including the data storage unit, according to the first embodiment. As shown in FIG. 2, a fish counting device 110 including a data storage unit further includes a measurement image storage section 31, a fish position storage section 32, a fish movement line storage section 33, and a fish count storage section 34. As shown in FIG. 2, the measurement image storage section 31, the fish position storage section 32, the fish movement line storage section 33, and the fish count storage section 34 may be incorporated in a data storage unit 30 that is hardware. In the fish counting device 110, the measurement image acquisition unit 11 is electrically connected to the measurement image storage section 31, the fish position acquisition unit 21 to the measurement image storage section 31 and the fish position storage section 32, the fish movement line calculation unit 22 to the fish position storage section 32 and the fish movement line storage section 33, and the fish counting unit 23 to the fish movement line storage section 33 and the fish count storage section 34.

The measurement image acquisition unit 11 stores the acquired measurement images in the measurement image storage section 31. The fish position acquisition unit 21 reads the measurement images out of the measurement image storage section 31, acquires the positions of the fish, and stores the positions of the fish in the fish position storage section 32. The fish movement line calculation unit 22 reads the positions of the fish out of the fish position storage section 32, calculates the movement lines of the respective fish, and stores the movement lines in the fish movement line storage section 33. The fish counting unit 23 reads the movement lines out of the fish movement line storage section 33, counts the fish to obtain a fish count, and stores the fish count in the fish count storage section 34. Other than this, the fish counting device 110 according to the present embodiment has the same configuration as the fish counting device 100 and can be described with reference to the description of the fish counting device 100.

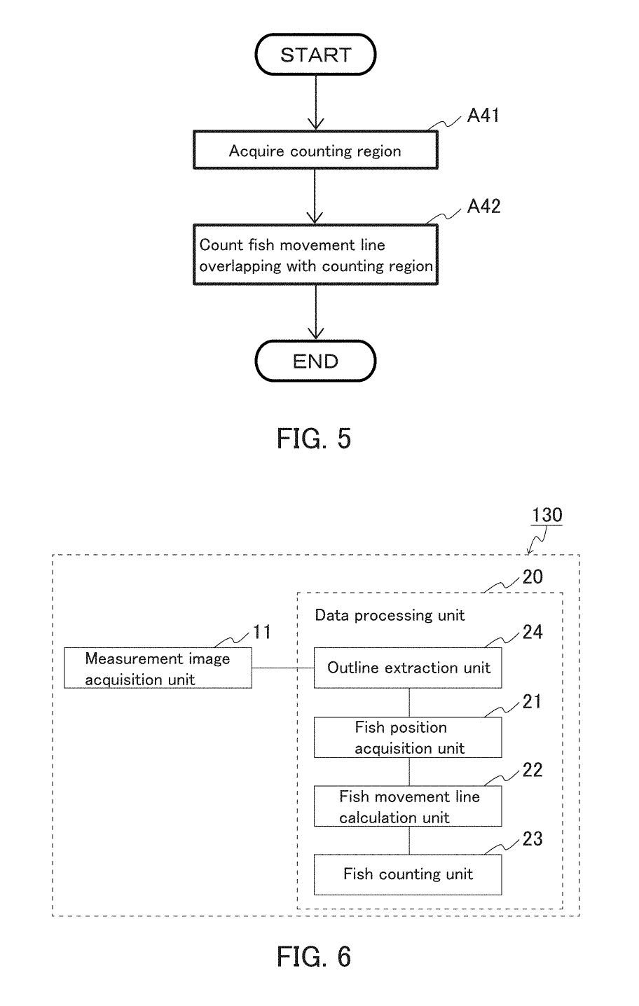

The fish counting device according to the present embodiment preferably further includes an input unit and an output unit. As shown in FIG. 3, a fish counting device 120 including a data storage unit further includes an input unit 41 and an output unit 42. In the fish counting device 120, the input unit 41 is electrically connected to the measurement image acquisition unit 11 and the fish counting unit 23, and the output unit 42 to the fish counting unit 23 and the fish count storage section 34. As the input unit 41, for example, any of a monitor such as a touch panel, a general-purpose input unit such as an operation key, included in a mobile terminal, a general-purpose input unit such as a keyboard and a mouse, included in a computer, an input file, and other computers can be used. The output unit 42 can be, for example, any of a monitor of video output (e.g., various image displays such as a liquid crystal display (LCD) and a cathode-ray tube (CRT) display), a printer of printing output, and a speaker of voice output. For example, with the input unit 41, information on start and stop of acquisition of the measurement images is input into the measurement image acquisition unit 11, and information on start and stop of counting the fish is input into the fish counting unit 23. At least either one of a fish count obtained by counting the fish by the fish counting unit 23 or a fish count stored in the fish count storage section 34 is output to the output unit 42. Other than this, the fish counting device 120 according to the present embodiment has the same configuration as the fish counting device 110. The fish counting device 120 includes the fish count storage section 34. However, for a fish counting device including no fish count storage section 34, the output unit 42 is electrically connected to the fish counting unit 23, and the fish count obtained by the fish counting unit 23 is output to the output unit 42. The fish counting device may include either one of the input unit 41 or the output unit 42 although the fish counting device 120 includes both of the input unit 41 and the output unit 42.

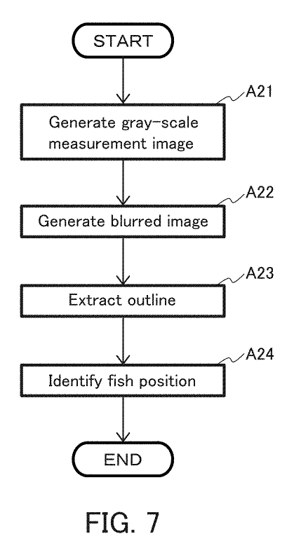

FIG. 4 is a flowchart of a fish counting method according to the present embodiment. The fish counting method according to the present embodiment is performed as follows using, for example, the fish counting device of FIG. 1. As shown in FIG. 4, the fish counting method according to the present embodiment includes a step A1 (measurement image acquisition), a step A2 (fish position calculation), a step A3 (fish movement line calculation), and a step A4 (fish counting).

(A1) Measurement Image Acquisition

In the step A1, a plurality of measurement images of a region to be measured in a passage region where a fluid containing fish passes through are acquired over time. For acquisition of the measurement images using the imaging unit, images of the passage region where a fluid containing fish passes through are taken and are acquired as the measurement images. For acquisition of the measurement images using the data storage unit, measurement images stored in the data storage unit are read out and are acquired.

(A) Fish Position Calculation (Fish Position Acquisition)

In the step A2, the positions of the fish in each of the measurement images are acquired. In the measurement images, the fish are detected by, for example, an extraction of outlines described below or a comparison between images of the fish stored in advance and the measurement images and a subsequent template matching of searching for similar regions. For example, the positions may be acquired by setting a coordinate plane in each of the measurement images and acquiring the positions as coordinates on the coordinate plane. Alternatively, for example, the positions may be acquired by setting a coordinate plane in the region to be measured and acquiring the positions as coordinates on the coordinate plane. When plural fish are present in each of the measurement images, the positions of the respective fish are acquired.

(A3) Fish Movement Line Calculation

In the step A3, movement lines of the fish as tracks of movements of the fish are calculated on the basis of the positions of the fish. The movement line of each fish can be calculated by, for example, making a line that connects between coordinates of each fish in previous and next measurement images on the basis of the order of acquiring the measurement images. The movement line of each fish can be calculated by, for example, known algorithms such as a Kalman filter, a particle filter, and KLT Manacle Lucas Tomasi) tracker.

(A4) Fish Counting

In the step A4, the fish are counted on the basis of the movement lines of the fish in the measurement images to obtain a fish count. For counting the fish, the movement lines of the fish are counted, and the obtained count is used as the count of the fish.

In the fish counting device and the fish counting method according to the present embodiment, the positions of fish is calculated from each of the measurement images, and movement lines of the fish are calculated on the basis of the positions. The fish are then counted on the basis of the movement lines of the fish. The fish counting device and the fish counting method according to the present embodiment thus allow fish to be counted easily with, for example, the fish counting device including a data processing unit. Moreover, a camera-equipped mobile terminal can be, for example, used as the fish counting device according to the present embodiment, and a cost thus can be reduced. The effects are the same as in the following embodiments.

[First Modification]

In a fish counting device according to the first modification, a fish counting unit preferably counts, as a fish count, movement lines overlapping with a counting region set in advance in the region to be measured among the movement lines calculated by the fish movement line calculation unit. Other than this, the fish counting device according to the first modification has the same configuration as the fish counting device according to the first embodiment.

The counting region is a region in which movement lines of fish overlapping with the counting region are counted as the fish. The conditions under which the counting region is set can be determined, as appropriate, according to, for example, the kind and the growth conditions of the fish.

The counting region may be set as a line or an area in the region to be measured.

The number of the counting regions is not limited to particular numbers and is, for example, 1 to 5, preferably 1 to 2, more preferably 1, for the reason that the cost can be reduced.

The position of the counting region set in the region to be measured is not limited to particular positions, and examples thereof include a central region, an end region, and other regions in the region to be measured. For the improvement of the accuracy of counting the fish, an area from one end to the other end in the region to be measured is preferably set as the counting region. For setting a plurality of the couting regions, the positions at which the counting regions are set in the region to be measured are positions with equal intervals from the end.

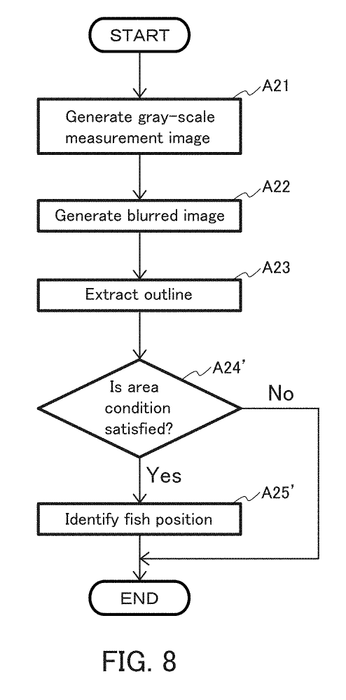

FIG. 5 is a flowchart of a fish counting method according to the first modification. the steps A1 to A3 in FIG. 5 are the same as those in the first counting method according to the first embodiment and thus are omitted. As shown in FIG. 5, a step A4 of the fish counting method according to the first modification includes a step A41 (counting region acquisition) and a step A42 (counting of movement lines of fish overlapping with couting region). Other than this, the fish counting method according to the first modification is the same as the fish counting method according to the first embodiment.

First, the steps A1 to A3 are performed as in the fish counting method according to the first embodiment.

(A41) Counting Region Acquisition

In the step A41, a counting region set in advance is acquired. The counting region is acquired as coordinates on a coordinate plane set in a region to be measured.

(A42) Counting of Movement Lines of Fish Overlapping with Counting Region

In the step A42, movement lines overlapping with the counting region set in advance in the region to be measured among the movement lines calculated by the fish movement line calculation unit are counted as the fish. For setting a plurality of counting regions, movement lines of the fish overlapping with any one of the counting regions may be determined and counted as the fish; movement lines of the fish overlapping with some of the counting regions may be determined and counted as the fish; or movement lines of the fish overlapping with all of the counting regions may be determined and counted as the fish. For the improvement of the accuracy of counting the fish, it is preferred that movement lines of the fish overlapping with all of the counting regions are determined and counted as the fish.

The fish counting device and the fish counting method according to the first modification can improve the accuracy of counting fish, and for example, the obtained fish count is highly reliable.

### Second Embodiment

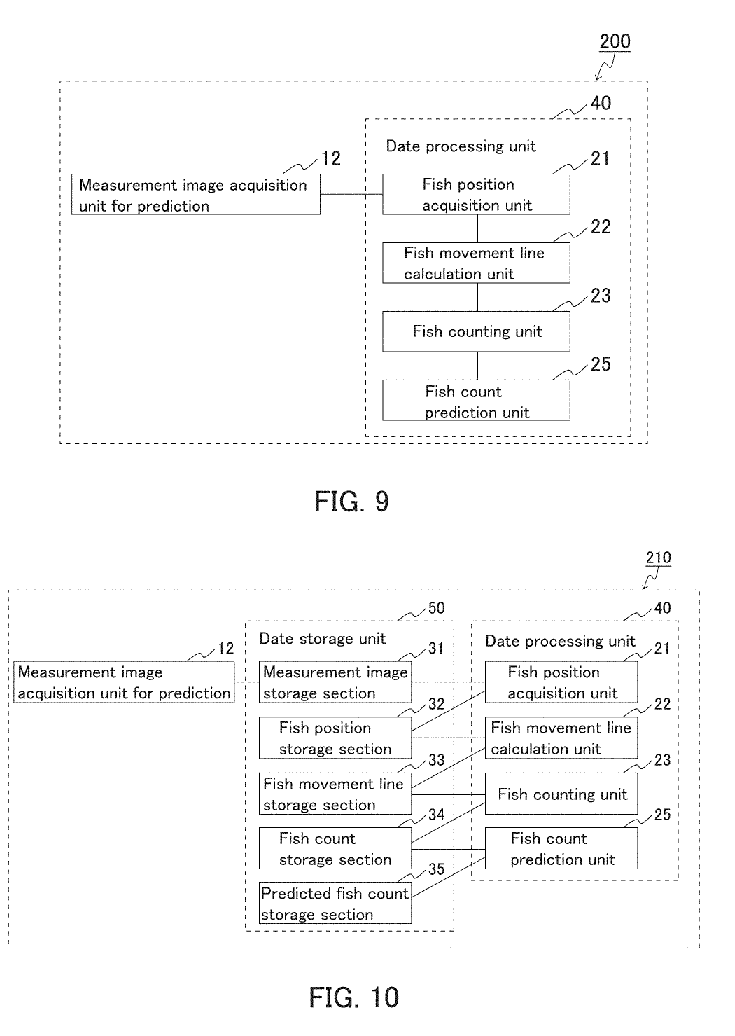

FIG. 6 is a block diagram of a fish counting device according to the present embodiment. As shown in FIG. 6, a fish counting device 130 according to the present embodiment further includes an outline extraction unit 24. The fish position acquisition unit 21 in the fish counting device 130 according to the present embodiment acquires the positions of fish on the basis of the positions of outlines in each of the measurement images. As shown in FIG. 6, the outline extraction unit 24 may be incorporated in the data processing unit 20. In the fish counting device 130 according to the present embodiment, the measurement image acquisition unit 11 is electrically connected to the outline extraction unit 24, and the outline extraction unit 24 to the fish position acquisition unit 21. Other than this, the fish counting device according to the present embodiment has the same configuration as the fish counting device 100 according to the first embodiment and can be described with reference to the description of the fish counting device according to the first embodiment.

The outline extraction unit 24 extracts outlines from each of the measurement images. The outlines can be outlines of, for example, fish in each of the measurement images. The outlines may be extracted from a part or the whole of each of the measurement images. The outlines may be extracted from a part or the hole of the region to be measured.

The fish position acquisition unit 21 acquires the positions of the fish on the basis of the positions of the outlines in each of the measurement images. The positions of the outlines can be, for example, the positions of the centers of gravity of the respective outlines.

In the fish counting device 130 according to the present embodiment, information on the measurement images is stored in the measurement image acquisition unit 11, information on the outlines is stored in the outline extraction unit 24, information on the positions of the fish is stored in the fish position acquisition unit 21, information on the movement lines of the fish is stored in the fish movement line calculation unit 22, and information on the fish count obtained by counting the fish is stored in the fish counting unit 23. The present invention, however, is by no means limited thereto, and the information may be stored in the data storage unit, and a subsequent unit may read the information out, as in the fish counting device 110 according to the first embodiment, for example.

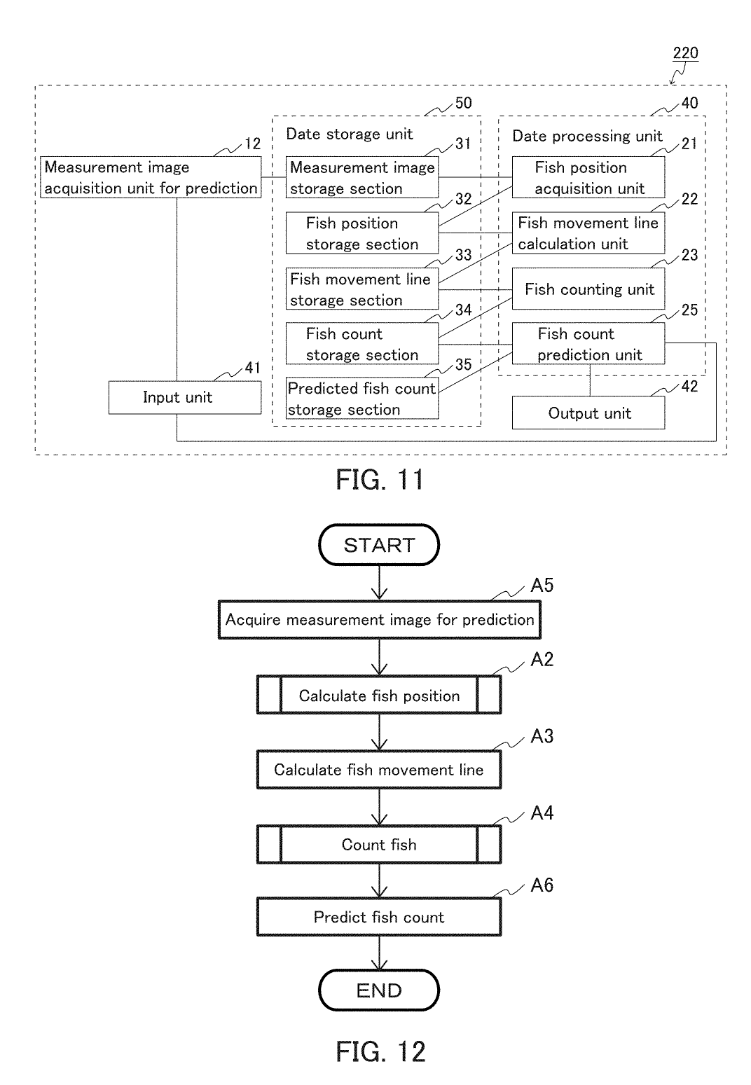

FIG. 7 is a flowchart of a fish counting method according to the present embodiment. In FIG. 7, the steps A1, A3, and A4 are the same as those in the fish counting method according to the first embodiment and thus are omitted. The fish counting method according to the second embodiment is performed as follows using the fish counting device of FIG. 6, for example. As shown in FIG. 7, a step A2 of the fish counting method according to the second embodiment includes a step A21 (gray-scale measurement image generation), a step A22 (blurred image generation), a step A23 (outline extraction), and a step A24 (fish position identification). Other than this, the fish counting method according to the present embodiment is the same as the fish counting method according to the first embodiment and can be described with reference to the description of the fish counting method according to the first embodiment.

First, the step A1 is performed in the same manner as in the fish counting method according to the first embodiment.

(A21) Gray-Scale Measurement Image Generation

In the step A21, measurement images are gray-scaled to generate gray-scaled measurement images. The gray-scaling is not limited to particular methods, and the gray-scaled images can be generated using, for example, OpenCV in an open-source image processing library.

(A22) Blurred Image Generation

In the step A22, the gray-scaled measurement images are subjected to blurring processing to generate blurred measurement images. The blurring processing is not limited to particular methods, and the blurred images can be generated using, for example, OpenCV in an open-source image processing library.

(A23) Outline Extraction

In the step A23, outlines are extracted from blurred measurement images. The extraction of the outlines is not limited to particular methods, and the outlines can be extracted using, for example, OpenCV in an open-source image processing library.

(A24) Identification of Position of Fish

In the step A24, the positions of the fish are acquired on the basis of the positions of the outlines in each of the measurement images. The positions are acquired by setting a coordinate plane in the region to be measured and acquiring the positions as coordinates on the coordinate plane. When plural outlines are present in each of the measurement images, the positions of the respective outlines are acquired as the positions of the respective fish.

Subsequently, the steps A3 and A4 are performed in the same manner as in the fish counting method according to the first embodiment.

The fish counting device and the fish counting method according to the present embodiment can extract outlines from measurement images and calculate the positions of fish on the basis of the positions of the outlines and thus can improve the accuracy of detecting the fish. The fish counting device and the fish counting method according to the present embodiment thus allow the obtained fish count to be highly reliable. Moreover, a camera-equipped mobile terminal can be, for example, used as the fish counting device according to the present embodiment, and a cost thus can be reduced. These effects are the same as in the following embodiments.

In the fish counting method according to the present embodiment, the steps A21 and A22 are optional steps, may or may not be included, and are however preferably included to easily extract the outlines. For the fish counting method including no steps A21 and A22, the outlines are extracted from each of the measurement images in the step A23.

[Second Modification]

The fish counting unit in the fish counting device according to the second modification preferably acquires the positions of, among the areas enclosed in the respective outlines, areas satisfying the area condition set in advance as the positions of the fish. Other than this, the fish counting device according to the second modification has the same configuration as the fish counting device according to the second embodiment and can be described with reference to the description of the fish counting device according to the second embodiment.

Examples of each of the areas enclosed in the respective outlines include the number of pixels of the area enclosed in each outline in the measurement images, the ratio of the area enclosed in each outline to the area of the measurement image, and the ratio of the area enclosed in each outline to the area of the region to be measured. Each of the areas enclosed in the respective outlines is preferably the ratio of the area enclosed in each outline to the area of the region to be measured so that the influence of the size of the measurement image can be reduced, and the error of the position of each fish among the measurement images can be reduced.

Conditions under which the area condition are set can be determined, as appropriate, according to, for example, the kind and the growth conditions of the fish. As the area condition, for example, a ratio (O/M) of an area (O) enclosed in each outline to an area (M) of the region to be measured is, for example, 1/100000 or more, preferably 1/17000 or more, more preferably 1/4000 or more.

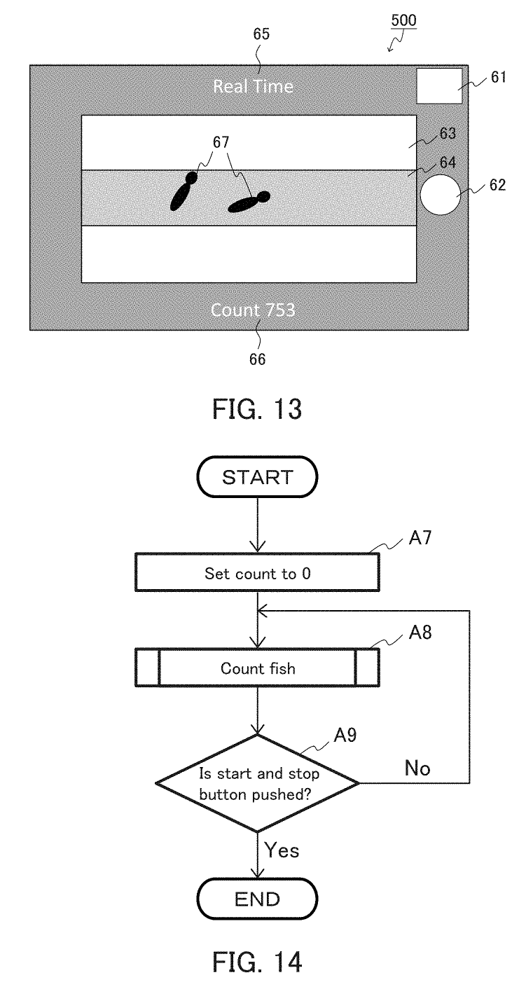

FIG. 8 is a flowchart of a fish counting method according to the second modification. In FIG. 8, the steps A1, A3, and A4 are the same as those in the fish counting method according to the second embodiment and thus are omitted. As shown in FIG. 8, a step A2 of the fish counting method according to the second modification further includes a step A24′ (area selection) and a step A25′ (fish position identification). Other than this, the fish counting method according to the second modification is the same as the fish counting method according to the second embodiment and can be described with reference to the description of the fish counting method according to the second embodiment.

The steps A1 and A21 to A23 are performed in the same manner as in the fish counting method according to the second embodiment.

(A24′) Area Selection

In the step A24′, whether or not each of the areas enclosed in the respective outlines satisfies the area condition set in advance is determined. If No, the outlines are determined as not fish, the step A25′ is not performed, and the positions of the outlines are not acquired as the positions of the fish. If Yes, the outlines are determined as fish, and the step A25′ is performed.

(A25′) Fish Position Identification

In the step A25′, the positions of the outlines determined as satisfying the area condition in the step A24′ are acquired as the positions of the fish.

In the fish counting device and the fish counting method according to the second modification, objects that are other than fish and passed through the region to be measured can be determined as no fish under the area condition set in advance, for example. The fish counting device and the fish counting method according to the second modification thus can improve the accuracy of detecting the fish. The fish counting device and the fish counting method according to the second modification thus allow the obtained fish count to be highly reliable.

### Third Embodiment

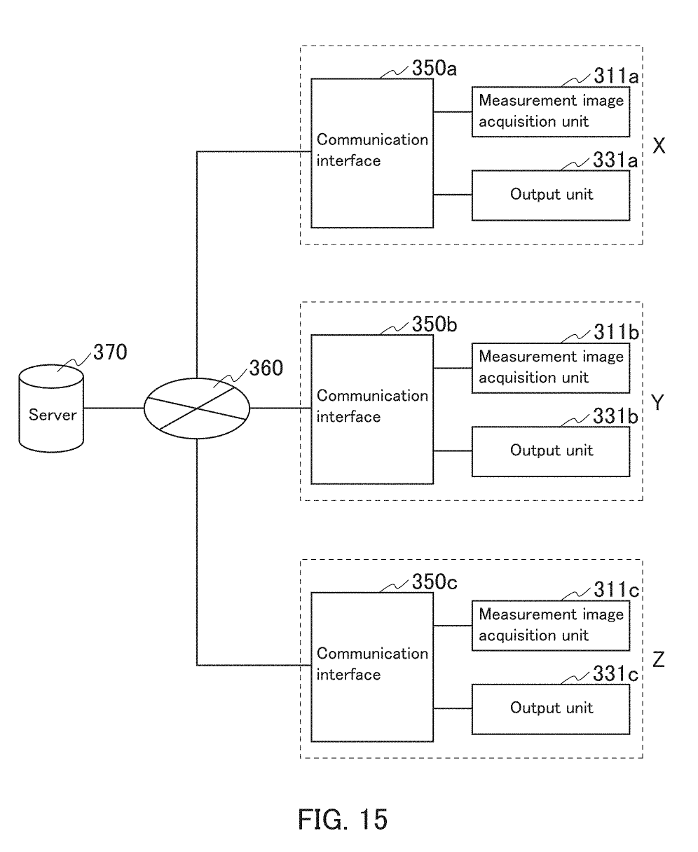

FIG. 9 is a block diagram of a fish count prediction device according to the present embodiment. As shown in FIG. 9, a fish count prediction device 200 according to the present embodiment includes, as main components, a measurement image acquisition unit (hereinafter also referred to as a “measurement image acquisition unit for prediction”) 12, a fish position acquisition unit 21, a fish movement line calculation unit 22, a fish counting unit 23, and a fish count prediction unit 25. As shown in FIG. 9, the fish position acquisition unit 21, the fish movement line calculation unit 22, the fish counting unit 23, and the fish count prediction unit 25 may be incorporated in a data processing unit 40 or may be software or hardware incorporating the software. In the fish counting device 200 according to the present embodiment, the measurement image acquisition unit 12 for prediction is electrically connected to the fish position acquisition unit 21, the fish position acquisition unit 21 to the fish movement line calculation unit 22, the fish movement line calculation unit 22 to the fish counting unit 23, and the fish counting unit 23 to the fish count prediction unit 25. The data processing unit 40 may include, for example, a CPU. In the fish count prediction device 200 according to the present embodiment, the fish position acquisition unit 21, the fish movement line calculation unit 22, and the fish counting unit 23 are the same as those in the fish counting device 100 according to the first embodiment and can be described with reference to the descriptions of those in the fish counting device 100 according to the first embodiment.

The measurement image acquisition unit 12 for prediction acquires measurement images of a region to be measured in a passage region where a fluid containing fish passes through within time set in advance. The time set in advance is not limited to particular time and can be determined, as appropriate, based on the volume of the fluid and the density of the fish in the fluid. Other than this, the measurement image acquisition unit 12 for prediction is the same as the measurement image acquisition unit 11 according to the first embodiment and can be described with reference to the description of the measurement image acquisition unit 11.

The fish count prediction unit 25 predicts a fish count of fish passed through the passage region on the basis of the fish count obtained by counting, by the fish counting device, i.e., for example, the fish counting unit 23, the fish in the measurement images acquired within time set in advance, the time set in advance, and total time required for the fluid containing fish to pass through the passage region.

In the fish count prediction device according to the present embodiment, the measurement images are stored in the measurement image acquisition unit 12 for prediction, the positions of the fish are stored in the fish position acquisition unit 21, the movement lines of the fish are stored in the fish movement line calculation unit 22, the fish count obtained by counting the fish is stored in the fish counting unit 23, and the predicted fish count is stored in the fish count prediction unit 25. The present invention, however, is by no means limited thereto, and the information may be stored in a data storage unit, and a subsequent unit may read the information out of the data storage unit.

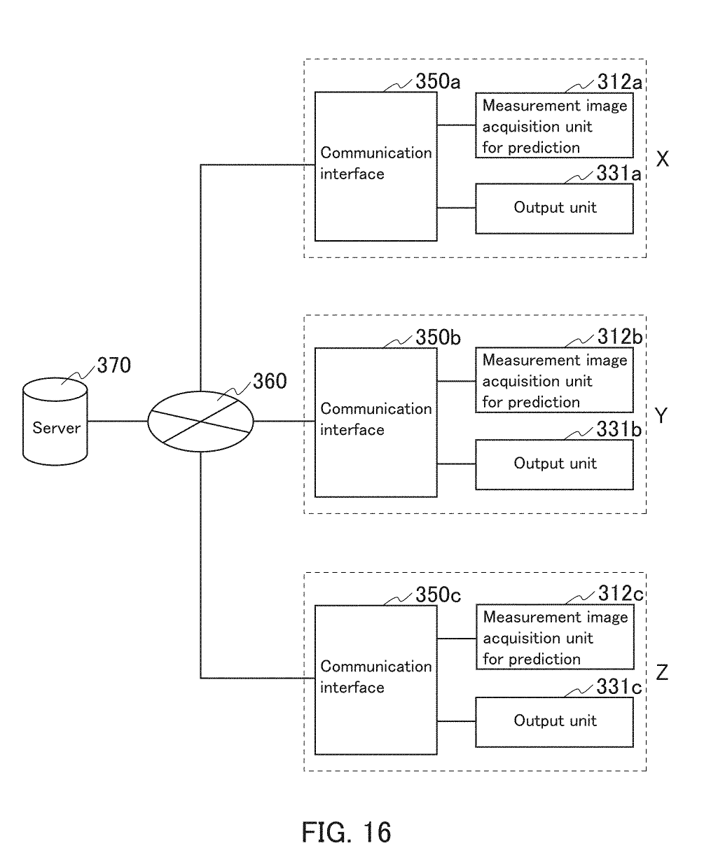

FIG. 10 is a block diagram of another fish count prediction device according to the present embodiment, including a data storage unit. As shown in FIG. 10, a fish count prediction device 210 including a data storage unit further includes a measurement image storage section 31, a fish position storage section 32, a fish movement line storage section 33, a fish count storage section 34, and a predicted fish count storage section 35. As shown in FIG. 10, the measurement image storage section 31, the fish position storage section 32, the fish movement line storage section 33, the fish count storage section 34, and the predicted fish count storage section 35 may be incorporated in a data storage unit 50 which is hardware. In the fish count prediction device 210, the measurement image acquisition unit 12 for prediction is electrically connected to the measurement image storage section 31, the fish position acquisition unit 21 to the measurement image storage section 31 and the fish position storage section 32, the fish movement line calculation unit 22 to the fish position storage section 32 and the fish movement line storage section 33, the fish counting unit 23 to the fish movement line storage section 33 and the fish count storage section 34, and the fish count prediction unit 25 to the fish count storage section 34 and the predicted fish count storage section 35.

The measurement image acquisition unit 12 causes the acquired measurement images to be stored in the measurement image storage section 31. The fish count prediction unit 25 reads an obtained fish count acquired from the fish count storage section 34 out, predicts a fish count, and causes the predicted fish count to be stored in the predicted fish count storage section 35. Other than this, the fish count prediction device 210 according to the present embodiment has the same configuration as the fish counting device 110 and can be described with reference to the description of the fish counting device 110.

The fish count prediction device according to the present embodiment preferably further includes an input unit and an output unit. As shown in FIG. 11, the fish count prediction device 220 including a data storage unit further includes an input unit 41 and an output unit 42. In the fish counting device 220, the input unit 41 is electrically connected to the measurement image acquisition unit 12 for prediction and the fish count prediction unit 25, and the output unit 42 to the fish count prediction unit 25 and the predicted fish count storage section 35. With the input unit 41, information on, for example, start and stop of acquisition of the measurement images is input to the measurement image acquisition unit 12 for prediction, and information on, for example, start and stop of prediction of a fish count is input to the fish count prediction unit 25. With the output unit 42, at least either one of the fish count predicted by the fish count prediction unit 25 or the predicted fish count stored in the predicted fish count storage section 35 is output. Other than this, the fish count prediction device 220 according to the present embodiment has the same configuration as the fish counting device 120 and can be described with reference to the description of the fish counting device 120 with reading the “fish counting device” as the “fish count prediction device”, the “fish counting device 120” as the “fish count prediction device 220”, the “fish counting unit 23” as the “fish count prediction unit 25”, and the “fish count storage section 34” as the “predicted fish count storage section 35”.

FIG. 12 is a flowchart of a fish count prediction method according to the present embodiment. The fish counting method according to the present embodiment is, for example, performed as follows using the fish count prediction device of FIG. 11. As shown in FIG. 12, the fish counting method according to the present embodiment includes a step A5 (measurement image acquisition for prediction), a step A2 (fish position calculation), a step A3 (fish movement line calculation), a step A4 (fish counting), and a step A6 (fish count prediction). The steps A2, A3, and A4 in the fish count prediction method according to the present embodiment are the same as those in the fish counting method according to the first embodiment and can be described with reference to the description of those in the fish counting method according to the first embodiment.

(A5) Measurement Image Acquisition for Prediction

In the step A5, a plurality of measurement images of a region to be measured in a passage region where a fluid containing fish passes through within time set in advance is acquired. For acquisition of the measurement images by an imaging unit, images of the passage region where a fluid containing fish passes through are taken within time set in advance and are acquired. For acquisition of the measurement images by a data storage unit, measurement images taken within time set in advance are read out and acquired among measurement images stored in the data storage unit.

The steps A2 to A4 are then performed in the same manner as in the fish counting method according to the first embodiment.

(A6) Fish Count Prediction

In the step A6, a fish count of fish passed through the passage region is predicted on the basis of the fish count (C) obtained by counting the fish in the measurement images acquired within time set in advance, the time (S) set in advance, and total time (T) required for the fluid containing the fish to pass through. The predicted fish count (P) can be calculated by the following formula (1), for example.

P=C×(T/S) (1)

P: predicted fish count

C: obtained fish count

S: time set in advance

T: total time required for fluid containing fish to pass through

In the fish count prediction device and the fish count prediction method according to the present invention, the positions of the fish are calculated from each of the measurement images acquired within the time set in advance, movement lines of the fish are calculated from the positions of the fish. Moreover, a fish count is then obtained on the basis of the movement lines of the fish, and a total fish count is predicted from the obtained fish count. Thus, for example, the fish count prediction device and the fish count prediction method according to the present embodiment allows a device including a data processing unit to predict a fish count, resulting in easy prediction of a fish count. Moreover, for example, a camera-equipped mobile terminal can be used as the fish count prediction device according to the present embodiment, and a cost thus can be reduced.

The fish position acquisition unit, the fish movement line calculation unit, and the fish counting unit in the fish count prediction device according to the present embodiment may be those in the second embodiment, the first modification, or the second modification or a combination of those in the second embodiment, the first modification, and the second modification and can be described with reference to the description of those. Moreover, the steps A2, A3, and A4 in the fish count prediction method according to the present embodiment may be those in the second embodiment, the first modification, or the second modification or a combination of those in the second embodiment, the first modification, and the second modification and can be described with reference to the description of those.

### Fourth Embodiment

An operation screen and a flowchart of an operation of the fish counting device and the fish count prediction device are described below with reference to FIGS. 13 and 14. FIG. 13 shows an operation screen of the fish counting device. As shown in FIG. 13, an operation screen 500 of the fish counting device according to the present embodiment includes an operation mode change button 61, a start and stop button 62, a measurement image 63, a region to be measured 64, an operation mode display 65, and a fish count display 66. A region to be measured 64 of the measurement image 63 contains, for example, fish 67.

With the operation mode change button 61, an operation mode of the fish counting device can be changed, for example, between a real-time mode of acquiring a measurement image 63 from the imaging unit and a recording mode of reading and acquiring the measurement image 63 out of the data storage unit.

With the start and stop button 62, counting of the fish is started and stopped. For the real-time mode as the operation mode, with the start and stop button 62, taking images by the imaging unit can be started at the time when counting of the fish is started, and taking images by the imaging unit can be stopped at the time when counting of the fish is stopped. The start and the stop are performed with one start and stop button in the present embodiment and however may be performed separately with different buttons. The start and stop button 62 may have, for example, a function of pausing.

The operation mode display 63 displays an operation mode of the fish counting device.

The fish count display 66 displays a fish count obtained by counting the fish using the fish counting device.

An operation of the fish counting device with the start and stop button 62 is described below with reference to FIG. 14. FIG. 14 is a flowchart of an operation of the fish counting device. As shown in FIG. 14, the operation includes a step A7 (count reset), a step A8 (fish counting), and a step A9 (stop determination).

(A7) Count Reset

When an operation of the start of counting of the fish is performed with the start and stop button 62, the fish count display 66 is set to display 0 in the step A7.

(A8) Fish Counting

In the step A8, fish 67 passed through a region 64 to be measured are counted by the fish counting method.

(A9) Stop Determination

In the step A9, whether an operation of the stop of counting of the fish is performed with the start and stop button 62 is determined. If No, it is determined that the stop operation of counting of the fish is not performed, and the step is returned to the step A8 to continuously count the fish. If Yes, it is determined that the stop operation of counting of the fish is performed, and the counting of the fish is stopped.

An operation screen and an operation of the fish count prediction device are described below. The operation screen of the fish count prediction device according to the present embodiment has the same configuration as that of the fish counting device except that a fish count predicted in the fish count prediction device is displayed on the fish count display 66. The operation screen of the fish count prediction device according to the present embodiment can be described with reference to the description of the operation screen of the fish counting device with reading the “fish counting device” as the “fish count prediction device”, and the “obtained fish count” as “the predicted fish count”. Moreover, the operation of the fish count prediction device is the same as that of the fish counting device except that a fish count is predicted by the fish count prediction method when an operation of starting a prediction of a fish count is performed. The operation of the fish count prediction device according to the present embodiment can be described with reference to that of the fish counting device with reading the “fish counting device” as the “fish count prediction device”, the “counting of fish” as the “prediction of fish count”, the “fish counting method” as the “fish count prediction method”, and “counting fish 67” as “predicting a fish count”.

### Fifth Embodiment

A program according to the present embodiment is a program configured to execute the fish counting method or the fish count prediction method on a computer. The program according to the present embodiment may be, for example, recorded on a computer-readable recording medium. The recording medium is not limited to particular media, and examples thereof include a random access memory (RAM), a read-only memory (RAM), a hard disc (HD), an optical disc, and a floppy (registered trademark) disc (FD).

### Sixth Embodiment

FIG. 15 shows a configuration of a fish counting system according to the present embodiment using the fish counting device of the present invention. As shown in FIG. 15, the fish counting system according to the present embodiment includes measurement image acquisition units 311a, 311b, and 311c, output units 331a, 331b, and 331c, communication interfaces 350a, 350b, and 350c, and a server 370. The measurement image acquisition unit 311a and the output unit 331a are connected to the communication interface 350a. The measurement image acquisition unit 311a, the output unit 331a, and the communication interface 350a are installed in a place X. The measurement image acquisition unit 311b and the output unit 331b are connected to the communication interface 350b. The measurement image acquisition unit 311b, the output unit 331b, and the communication interface 350b are installed in a place Y. The measurement image acquisition unit 311c and the output unit 331c are connected to the communication interface 350c. The measurement image acquisition unit 311c, the output unit 331c, and the communication interface 350c are installed in a place Z. The communication interfaces 350a, 350b, and 350c and the server 370 are connected via a line network 360.

In this fish counting system, a fish position acquisition unit, a fish movement line calculation unit, and a fish counting unit are stored in the server 370. For example, a plurality of measurement images acquired using the measurement image acquisition unit 311a is sent to the server 370, and fish are counted in the server 370 to obtain a fish count. The obtained fish count is then output from the output unit 311a.

The fish counting system according to the present embodiment allows the measurement image acquisition units and the output units to be installed at the site, the server and the like to be installed at another place, and fish to be counted online Thus, a large space for the device is not required, and the device can be easily maintained. Moreover, for the installation places of the units apart from one another, the units can be controlled centrally and remotely operated. The fish counting system according to the present embodiment may be compatible with the fish counting device and the fish counting method of the second embodiment, the first modification, the second modification, or a combination thereof. The fish counting system according to the present embodiment may be compatible with cloud computing. Moreover, in the fish counting system according to the present embodiment, the communication interfaces 350a, 350b, and 350c and the server 370 may be connected via a radio line.

### Seventh Embodiment

FIG. 16 shows a configuration of a fish count prediction system according to the present embodiment using the fish count prediction device of the present invention. As shown in FIG. 16, the fish count prediction system according to the present embodiment has the same configuration as the fish counting system according to the sixth embodiment except that the fish count prediction system includes images acquisition units 312a, 312b, and 312c for prediction as substitute for the measurement image acquisition units 311a, 311b, and 311c, and a fish count prediction unit is further stored in the server 370. The fish count prediction system according to the present embodiment can be described with reference to the description of the sixth embodiment with reading the “measurement image acquisition unit” as the “measurement image acquisition unit for prediction”, the “measurement image acquisition units 311a, 311b, and 311c” as the “measurement image acquisition units 312a, 312b, and 312c for prediction”, respectively, “the fish position acquisition unit, the fish movement line calculation unit, and the fish counting unit” as “the fish position acquisition unit, fish movement line calculation unit, fish counting unit, and fish count prediction unit”, the “fish counting system” as the “fish count prediction system”, the “counting fish” as “predicting a fish count”, and the “obtained fish count” as the “predicted fish count”.

The present invention is described above with reference to the exemplary embodiments. The present invention, however, is by no means limited thereto. Various changes and modifications that may become apparent to those skilled in the art may be made in the configuration and specifics of the present invention without departing from the scope of the present invention.

This application is based upon and claims the benefit of priority from Japanese patent application No. 2014-208835, filed on Oct. 10, 2014, the disclosure of which is incorporated herein its entirety by reference.

### INDUSTRIAL APPLICABILITY

The present invention can provide an easily fish counting device, a fish counting method, a fish count prediction device, a fish count prediction method, a fish counting system, and a fish count prediction system. The present invention allows fish to be counted simply. The present invention is therefore really useful in, for example, an aquaculture field and a fishery field.

### EXPLANATION OF REFERENCE NUMERALS

11 measurement image acquisition unit
12 measurement image acquisition unit for prediction
20, 40 data processing unit
21 fish position acquisition unit
22 fish movement line calculation unit
23 fish counting unit
24 outline extraction unit
25 fish count prediction unit
30, 50 data storage unit
31 measurement image storage section
32 fish position storage section
33 fish movement line storage section
34 fish count storage section
35 predicted fish count storage section
41 input unit
42 output unit
61 operation mode change button
62 start and stop button
63 measurement image
64 region to be measured
65 operation mode display
66 fish count display
67 fish
100, 110, 120, 130 fish counting device
200, 210, 220 fish count prediction device
311a, 311b, 311c measurement image acquisition unit
312a, 312b, 312c measurement image acquisition unit for prediction
331a, 331b, 331c output unit
350a, 350b, 350c communication interface
360 line network
370 server
500 operation screen

What is claimed is:

1. A fish counting device comprising at least one processor configured to:
acquire, over time, a plurality of measurement images of a region to be measured in a passage region where a fluid containing at least one fish passes through;
acquire positions of the at least one fish in the plurality of measurement images;
calculate a movement line of the at least one fish as a track of movement of the at least one fish on the basis of the acquired positions; and
count the at least one fish on the basis of the movement line of the at least one fish in the plurality of measurement images, to obtain a fish count.

2. The fish counting device according to claim 1, wherein
when the movement line overlaps with a counting region set in advance in the region to be measured, the processor is configured to count the movement line as the at least one fish.

3. The fish counting device according to claim 1, the processor further configured to:
extract an outline from each of the plurality of measurement images, wherein
the processor is configured to acquires the position of the at least one fish on the basis of the position of the outline in the plurality of measurement images.

4. The fish counting device according to claim 3, wherein
when an area enclosed in the outline satisfies an area condition set in advance, the processor is configured to acquire the position of the outline as the position of the at least one fish.

5. A fish counting method for counting fish, the fish counting method comprising:
acquiring, over time, a plurality of measurement images of a region to be measured in a passage region where a fluid containing the at least one fish passes through;
acquiring positions of the at least one fish in the plurality of measurement images;
calculating a movement line of the at least one fish as a track of movement of the at least one fish on the basis of the acquired positions; and
couting the at elast one fish on the basis of the movement line of the at least one fish in the plurality of measurement images to obtain a fish count.

6. The fish counting method according to claim 5, wherein
when the movement line overlaps with a counting region set in advance in the region to be measured, the movement line is counted as the at least one fish.

7. The fish counting method according to claim 5, further comprising:
extracting outlines from the plurality of measurement images, wherein
the position of the at least one fish is acquired on the basis of the positions of the extracted outlines.

8. The fish counting method according to claim 7, wherein
when an area enclosed in the outline satisfies an area condition set in advance, the position of the outline is acquired as the position of the at least one fish.

9-10. (canceled)

11. A program configured to execute the fish counting method according to claim 5 on a computer.

12-14. (canceled)
